(19) United States
(12) Patent Application Publication
(10) Pub. No.: US 2025/0126560 A1
(43) Pub. Date: Apr. 17, 2025

(54) ADAPTIVE POWER-SAVE MODE MANAGEMENT METHODS AND DEVICES IN A WIRELESS COMMUNICATION NETWORK

(71) Applicant: Morse Micro Pty. Ltd., Surry Hills NSW (AU)

(72) Inventor: Andrew Pope, Surry Hills NSW (AU)

(21) Appl. No.: 18/774,848

(22) Filed: Jul. 16, 2024

(30) Foreign Application Priority Data
Oct. 16, 2023 (AU) 2023903292

(51) Int. Cl. H04W 52/02; H04W 28/02

(52) U.S. Cl. CPC H04W 52/0232; H04W 28/0284

(57) ABSTRACT

Methods and devices in a wireless communication network wake up from a power-save mode, receive a beacon frame, determine the received beacon frame is advertising there is buffered data traffic, staying awake for a period of time waiting for the buffered data traffic, determine there is a data frame delivering to another device in the wireless communication network, and extend the period of time waiting for the buffered data traffic in response to determining there is a data frame delivering to another device. Some embodiments extend the period of time when there is a data frame delivering to another device until the period of time reaches a maximum threshold. In some embodiments, the device determines whether the network is going to remain congested and adaptively enters the power-save mode when the network is going to remain congested.

The present application claims priority from Australian provisional patent application number 2023903292 filed on 16 Oct. 2023, the contents of which are incorporated herein by cross-reference.

### FIELD OF THE INVENTION

The present disclosure generally relates to wireless communications. Specifically, aspects of the present disclosure are related to adaptive power-save mode management in wireless communications.

### BACKGROUND

A Wireless Local Area Network (WLAN) is a wireless communication network that uses radio waves for connecting devices within a limited area. Most WLANs are based upon one of the IEEE 802.11 standards (Wi-Fi). Some examples of the popular WLAN standards include IEEE 802.11ac (Wi-Fi 5), IEEE 802.11ah (Wi-Fi HaLow), IEEE 802.11ax (Wi-Fi 6), and IEEE 802.11be (Wi-Fi 7). Each of the devices connected to the WLAN is either an Access Point (AP) providing services or a client station (STA). A Basic Service Set (BSS) typically contains an AP and a group of STAs wirelessly communicating at a physical layer level. An AP is the master which configures and maintains the network and associates all valid STAs and transmits beacon frames periodically to convey the details to the associated STAs in the BSS. While STAs offer the convenience of wireless connectivity, there are several challenges that can affect the overall network performance and user experience, the challenges include maintaining a proper signal strength and coverage, preventing network congestions, and resolving interferences. In crowded or densely populated areas, the WLAN can be congested as too many STAs are trying to connect to the AP simultaneously. This wireless communication congestion may lead to overall reduced data speeds, increased latency, and intermittent connectivity for STAs in the WLAN.

In order to minimize the power consumption of battery-powered STAs, each STA may be configured to enter a power-save mode most of its standby time and periodically exit the power-save mode to receive a beacon frame broadcasted from the associated AP of the BSS. The power-save mode is frequently being referred to as sleeping mode, and a STA entering sleeping mode is described as it is going to sleep while exiting sleeping mode is described as it is waking up. A bitmap in a beacon frame indicates which sleeping STA(s) in the BSS has pending data buffered in the AP. The AP periodically transmits this bitmap in an Information Element (IE) of the beacon frame to advertise there is pending data traffic for one or more sleeping STAs. The sleeping STA is configured to wake up and receive a beacon frame from the AP to synchronize with the wireless network and to determine whether it needs to stay awake to receive data traffic from the AP according to the bitmap in the received beacon frame. In cases when the bitmap indicates there is buffered data for the STA, the STA transmits a notification, such as a Quality of Service (QoS) Null Data frame with the power management bit set to 0, to the AP indicating it has exited a power-save mode. The bitmap may be conveyed to the STAs using a Traffic Indication Map (TIM), where each bit of the TIM corresponds to an Association ID (AID) representing a STA in the BSS. The AP may only transmit a portion of the bitmap when it only has data for a few STAs, and the transmitted portion is referred to as a partial virtual bitmap. The AP may transmit buffered data traffic to the STA after receiving the awake notification from the STA. The STA transmits a notification, for example, a QoS Null Data frame with the power management bit set to 1, to inform the AP that it will enter the power-save mode after receiving the data traffic from the AP or after a timeout.

Beacon frames including a Delivery Traffic Indication Map (DTIM) are referred to as DTIM beacon frames in the description, where DTIM beacon frames are used to advertise any broadcast and/or multicast data buffered at the AP for multiple STAs in the BSS. All STAs wake up at each Target Beacon Transmission Time (TBTT) to receive this DTIM beacon frame. Following a DTIM beacon frame that indicates there is broadcast and/or multicast data, the AP releases the buffered broadcast and/or multicast data to the STAs in the BSS. A DTIM period value indicates how often a beacon frame includes a DTIM. The DTIM period may be configured to balance the data throughput and the power consumption of the STA, where a longer DTIM period reduces the power consumption but also reduces the data throughput, and vice versa. A STA may sleep for one or more beacon intervals by notifying the AP a listen interval, which indicates how frequently it will wake up to receive a beacon frame, similarly, a larger listen interval enables the STA to save more power by sleeping for a longer time, however, the AP may require to buffer more frames for this STA.

### SUMMARY

The following summary presents technical features relating to one or more aspects disclosed herein and should not be considered as an extensive overview relating to all contemplated aspects, nor should the following summary be considered to identify key or critical elements relating to all contemplated aspects or to delineate the scope associated with any aspect. Accordingly, the following summary has the sole purpose to present certain concepts relating to one or more embodiments relating to the signaling methods disclosed herein in a simplified form to precede the detailed description presented below.

Disclosed are various embodiments of the power-save mode management method for a station (STA) wirelessly connecting with an Access Point (AP) of a wireless communication network. The power-save mode management method comprises waking up from a power-save mode, receiving a beacon frame transmitted from the AP, determining the received beacon frame is advertising there is buffered data traffic for the STA, in response to the received beacon frame advertising there is buffered data traffic for the STA, keeping the STA to stay awake for a period of time waiting for the buffered data traffic from the AP, determining there is a data frame delivering to a peer STA in the wireless communication network, and extending the period of time waiting for the buffered data traffic in response to determining there is a data frame delivering to a peer STA. The power-save mode management method further comprises entering the power-save mode at least after the period of time waiting for the buffered data traffic. The peer STA is a STA connecting to the AP in the wireless communication network. The period of time is extended to make the STA stay awake for a longer time waiting for the buffered data traffic in response to a busy network.

In some embodiments, keeping the STA to stay awake for a period of time comprises setting a first timer to a first predetermined amount of time when receiving the beacon frame advertising there is buffered data traffic for the STA, and extending the first timer when there is a data frame delivering to a peer STA. The STA enters the power-save mode when the first timer is timeout. The STA sets a second timer and clears the first timer when it receives a data frame from the AP. The second timer is set to keep the STA awake for a second predetermined amount of time after receiving the data frame waiting for more data frames. The STA may extend the second timer every time when receiving a data frame indicating there is at least one more data frame to be delivered to the STA. In one example, the second timer is extended by setting the second timer to the second predetermined amount of time every time when receiving a data frame indicating there is at least one more data frame to be delivered to the STA. The STA sends a notification to the AP indicating it is going to sleep when the first or second timer is timeout and then the STA enters the power-save mode. In some embodiments, the STA sets the first timer to the first predetermined amount of time each time when there is a data frame delivering to a peer STA in the wireless communication network.

Some embodiments of the power-save mode management method restrict the wake up time waiting for the data traffic from the AP, for example, the STA compares the period of time the STA is awake and not receiving any data frame with a maximum threshold, and enters the power-save mode when the period of time reaches the maximum threshold. In some embodiments, the power-save mode management method further comprises sending a notification to the AP indicating the STA is going to sleep and entering the power-save mode after the STA stays awake for the period of time. An embodiment of the STA determines whether there is a data frame delivering to a peer STA by observing data traffic transmitted from the AP.

In some embodiments, keeping the STA to stay awake comprises setting a timer to countdown the period of time waiting for the buffered data traffic after receiving the beacon frame advertising there is buffered data traffic for the STA. For example, the period of time can be extended by setting the timer to a predetermined amount of time each time the STA determines that a data frame is delivering to a peer STA. In another example, the period of time can be extended by incrementing the timer by a predetermined amount of time each time the STA determines that a data frame is delivering to a peer STA. In some embodiments, the timer maintains a first timestamp for determining the period of time waiting for the buffered data traffic after receiving the beacon frame advertising there is buffered data traffic for the STA, and maintains a second timestamp for determining data traffic timeout after receiving a data frame for the STA. For example, the first timestamp is programmed into the timer after receiving the beacon frame from the AP, and the second timestamp is programmed into the timer after receiving a data frame for the STA from the AP. The STA enters the power-save mode when the timer is timeout.

Some embodiments of the power-save mode management method evaluate how busy the network is and accordingly stay awake waiting for data traffic or return to the power-save mode. For example, the STA wakes up and receives a beacon frame advertising there is buffered data traffic for the STA, and it determines if the wireless communication network is going to remain congested. The STA enters the power-save mode in response to determining that the wireless communication network is going to remain congested, and the STA stays awake waiting for the buffered data traffic from the AP. In an embodiment, the STA evaluates whether the wireless communication network is going to remain congested after waiting for the period of time. Some embodiments of the power-save mode management method further comprise negotiating a service period with the AP in response to determining that the wireless communication network is going to remain congested, entering the power-save mode after determining a negotiated service period, and waking up from the power-save mode according to the negotiated service period. For example, the STA determines whether the wireless communication network is going to remain congested by checking information present in a Basic Service Set (BSS) Load element of a beacon frame sent from the AP.

An aspect of the present invention discloses a STA wireless connecting to an AP in a wireless communication network, comprising a Radio Frequency (RF) receiver, an RF transmitter, at least a processor, and one or more memory banks. The memory banks are communicatively coupled to the processor and storing processor readable codes that, when executed by the processor, is configured to perform the power-save mode management method which prevent frequent switching between the power-save mode and the normal mode. The STA wakes up from a power-save mode, receives a beacon frame from the AP, and determines there is data traffic buffered in the AP according to the beacon frame. The STA stays awake for a period of time waiting for the buffered data traffic, determines there is a data frame delivering to a peer STA in the wireless communication network, and extends the period of time waiting for the buffered data traffic in response to determining there is a data frame delivering to a peer STA. The STA enters the power-save mode at least after the period of time, where this period of time is set to be longer when there is data traffic delivering to one or more other STAs in the wireless communication network.

Other objects and advantages associated with the aspects disclosed herein will be apparent to those skilled in the art based on the accompanying drawings and detailed description.

### BRIEF DESCRIPTION OF THE DRAWINGS

Illustrative aspects of the present application are described in detail below with reference to the following drawing figures:

FIG. 1 is a flowchart showing an embodiment of the power-save mode management method for a STA on a BSS to stay awake or go back to sleep by considering whether the AP is sending data traffic to a peer STA on the BSS.

FIG. 2 demonstrates an example of a conventional behavior of a station (STA2) after waking up from a power-save mode and receiving a beacon frame indicating there is data traffic buffered at the AP.

FIG. 3 demonstrates an example of a novel behavior of STA2 after waking up from a power-save mode according to an embodiment of the present invention.

FIG. 4. Shows information carried in a BSS Load Element of a beacon frame according to an embodiment.

FIG. 5 is a flowchart illustrating an embodiment of the power-save mode management method for a STA to negotiate a service period with an AP when it determines the network is going to remain congested.

FIG. 6 is a flowchart illustrating another embodiment of the power-save mode management method for a STA to negotiate a service period with an AP when it determines the network is going to remain congested.

FIG. 7 is a schematic block diagram of a wireless communication device for implementing an embodiment of the present invention.

### DETAILED DESCRIPTION

Certain aspects and embodiments of this disclosure are provided below. Some of these embodiments may be applied independently and some of them may be applied in conjunction as would be apparent to those of skill in the art. In the following description, for the purposes of explanation, specific details are set forth in order to provide a thorough understanding of aspects of the application. However, it will be apparent that various embodiments may be practiced without these specific details. The figures and description are not intended to be restrictive. The following description of the embodiments will provide those skilled in the art with an enabling description for implementing an example aspect. Changes may be made in the function and arrangement of elements without departing from the spirit and scope of the application as set forth in the claims.

From investigations of the data throughput in a multi-station BSS, the data throughput of STAs may reduce significantly, or even lead to a complete and persistent drop to zero throughput, when it toggles in and out of the power-save mode regularly. This behavior of the STAs is observed and investigated to understand what has caused the frequent power-save mode toggle. In cases when multiple simultaneous data streams are to be transmitted to multiple sleeping STAs on a BSS, the AP sets a TIM of a beacon frame indicating there is buffered data traffic for selective sleeping STAs. The STAs on the BSS wake up from a power-save mode to receive the beacon frame, and these selective STAs having data traffic buffered at the AP send awake notification, such as a QoS Null Data frame, to the AP to indicate that they are aware of the buffered data traffic indicated by the TIM of the beacon frame. The AP receiving the awake notifications from these selected STAs transmits the buffered data to the STAs one at a time, for example, the AP may have multiple First In First Out (FIFO) buffers with different priorities, and it sends the buffered data in the highest priority buffer first. Some STAs waiting for the data traffic may not receive any data for a period as the AP is busy sending out data to other STAs. Once the STA is awakened and acknowledged by the AP, the AP will not set the TIM field for the awakened STA in beacon frames even if it still has data traffic yet to send to this awakened STA. In this case, the STA will be awake waiting for data traffic, and it will only receive beacon frames with TIM indicating there is no data traffic for it. Unless the AP is actively feeding data to the STA after the initial TIM set, the STA will assume the AP has no more data traffic for it in the absence of data traffic because the newly received beacon frame indicates there is no data traffic buffered in the AP. After a predefined period of time waiting for the data traffic or upon receiving a beacon frame with a corresponding bit in the TIM clear indicating there's no data traffic for the STA, the STA sends a sleep notification to the AP, such as a QoS Null Data frame, and goes back to the power-save mode before any data traffic is delivered. Accordingly, the AP is forced to re-buffer the recently released data traffic to the STA. The AP's upper Medium Access Control (MAC) processor normally limits how many times a socket buffer (or so called SKB) can be rebuffered, in addition, the buffer queues may have a limited depth, so data may be dropped and never be deliver to the corresponding STA.

In the case of a single-station BSS, the AP delivers data traffic to the STA within a reasonable amount of time after the STA indicates it is awake. However, in a busy BSS with numerous STAs, when the AP has data traffic to send to multiple STAs, data transmission for some STAs can be delayed by a considerable amount of time after these STAs receive the beacon frame with the TIM set for them. During this considerable amount of time, the AP is sending data traffic to other STAs on the BSS. This behavior causes some STAs to stay awake waiting for data traffic for a while and go back to sleep before receiving any data from the AP due to timeout.

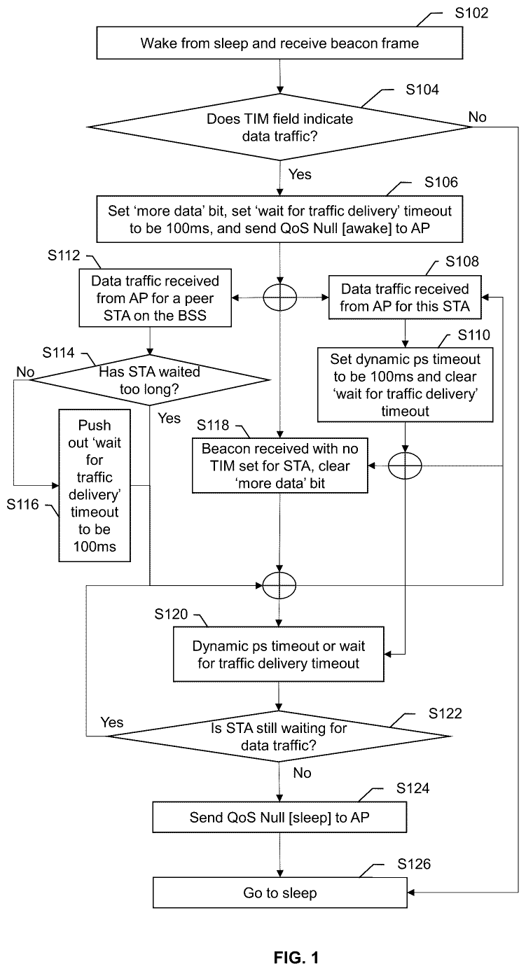

In order to improve the data through and network performance for this kind of busy BSS, embodiments of a method implemented in a wireless device prevent aggressive return to sleep after waking up from a power-save mode. FIG. 1 shows an embodiment of the method for managing a STA on a BSS to stay awake or go back to sleep after waking up from sleeping mode by considering whether the AP is sending data traffic to a peer STA on the BSS. As shown in the flowchart of FIG. 1, the STA wakes from a power-save mode and receives a beacon frame from the associated AP in step S102. The AP sets a corresponding bit in a TIM field of the beacon frame to indicate that there is data traffic to be delivered to the STA. The STA checks the TIM field of the received beacon frame in step S104 and goes back to sleep if the TIM field indicates there is no data traffic to be delivered to the STA in step S126. Upon reception of the beacon frame with the TIM field set, the STA sets an internal state to indicate that there is ‘more data’ to be received from the AP in step S106. The STA also sets a wait for traffic delivery timer and sends a QoS Null Data frame to the AP to indicate that the STA is now awake in step S106. For example, the STA sets the wait for traffic delivery timer to expire in 100 milliseconds (ms). During the 100 ms of the wait for traffic delivery timer set by the STA, if there is a data frame received from the AP as shown in step S108, the STA sets a dynamic power-save (ps) timer and clears the wait for traffic delivery timer in step S110. In some embodiments of managing the STA, the timeout of the dynamic ps timer is set to a certain amount of time each time the STA receives a data frame, for example, the dynamic ps timer is set to 100 ms each time when a new data frame is received from the AP, so even when the STA stops receiving, it will wait for an additional 100 ms before going back to sleep. In this embodiment, the timeout value of the dynamic ps timer is set to be the same as the one for the wait for traffic delivery timer, however, these two timers may be set with different timeout values.

In cases when the STA is awake and waiting for data traffic after sending a QoS Null Data frame to the AP, the STA continuously monitors whether there is data traffic transmitting to one or more peer STAs on the BSS by the AP before the wait for traffic delivery timer timeout. In step S112, the STA determines there is data traffic transmitted from the AP to a peer STA on the BSS. For example, the STA learns that there is data traffic transmitting to a peer STA by parsing data frames sent on the channel by the AP. The STA can set the wait for traffic delivery timer to a predetermined amount of time when there is a data frame sent from the AP targeting to another STA on the BSS, for example, the STA sets the wait for traffic delivery timer to 100 ms when it determines a data frame is sent to a peer STA. In step S114, the STA determines whether it has waited for too long, for example, the STA determines it waits for too long if the awake time exceeds a threshold. The wait for traffic delivery timer may be pushed out to be 100 ms in step S116 if the STA has not waited for too long. The STA may decide not to push out the wait for traffic delivery timer if it waited too long for the data traffic after receiving the beacon frame indicating there is data traffic. For example, the STA may have a limit on how many times it can push out the timeout of the wait for traffic delivery timer, or the STA may have another timer counting down for the time the STA is awake and not receiving any data traffic. In one example, the STA has a maximum awake time of 2 seconds, so it will go back to sleep after 2 seconds by setting the threshold to 2 seconds, even if the STA is aware that the AP is busy delivering data to some other STAs. The STA does this to conserve power. Since the AP receives a QoS Null Data frame indicating wake from the STA, it does not need to set the corresponding bit for the STA in the TIM field of the next beacon frame. In the absence of data traffic from the AP, and once observing the corresponding bit in the TIM is clear in a newly received beacon frame in step S118, the STA assumes that the AP has no more data traffic buffered for it and thus it clears the ‘more data’ bit. In step S120, when the dynamic ps timer or the wait for traffic delivery timer are timeout, the STA checks whether it is still waiting for data traffic in step S122. In step S124, the STA sends a QoS Null data to the AP indicating that it is going to sleep since the timer is timeout and the STA is not waiting for data traffic. The STA returns to the power save mode to go to sleep in step S126.

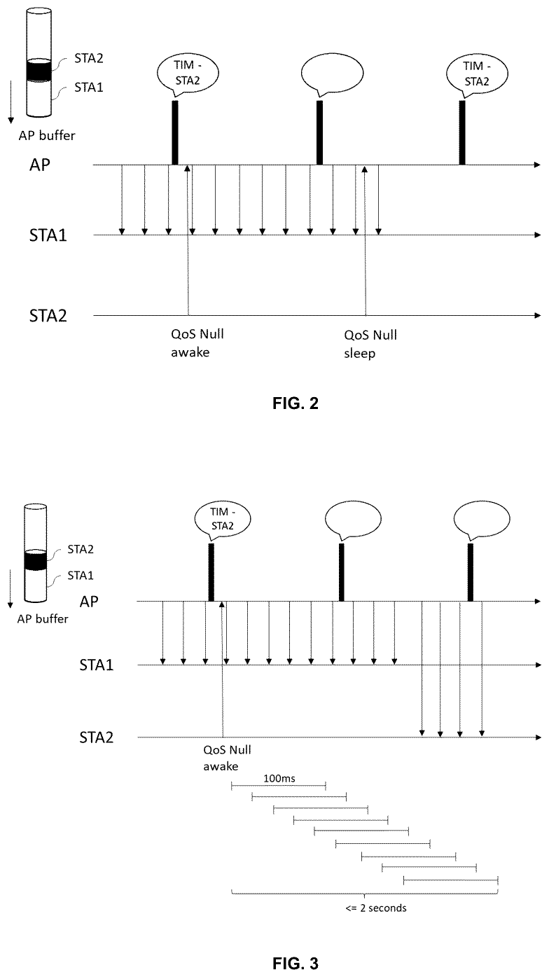

FIG. 2 shows an example of a conventional behavior of a station (STA2) after waking up from a power-save mode and receiving a beacon frame indicating there is data traffic buffered at the AP. The AP buffer stores data traffic to be transmitted to one or more STAs, for example, there are data traffic for both STA1 and STA2 stored in the AP buffer as shown in FIG. 2. In this example, STA2 wakes up to receive a beacon frame from the AP while the AP is transmitting data traffic to STA1. STA2 stays awake as the TIM field in the beacon frame indicates there is data traffic buffered at the AP for STA2. In response to the beacon frame, STA2 sends a QoS Null data frame to the AP indicating it is awake and ready to receive the data traffic. STA2 then waits for the data traffic to arrive, however, the data traffic for STA1 in the AP buffer arrives before the data traffic for STA2, or the data traffic for STA1 has a higher priority than the data traffic for STA2, the AP sends data frames to STA1 before it can send data frames to STA2. After a period of time, STA2 receives another beacon frame broadcasted by the AP, and because STA2 is not a sleeping station, the TIM field in the beacon frame no longer indicates there is data traffic for STA2. As a result, STA2 sends a QoS Null data frame indicating it is going back to sleep. In this example, the AP receives the QoS Null data frame from STA2 and since there is still data traffic in the AP buffer, it must set the TIM field again in the next beacon frame. STA2 thus toggles in and out of the power-save mode a number of times before it can receive the buffered data traffic from the AP.

FIG. 3 shows an example of a novel behavior of STA2 after waking up from a power-save mode according to an embodiment of the present invention. In this example, the AP of the BSS is still in the process of sending data frames to STA1 while STA2 wakes up from the power-save mode. STA2 receives a beacon frame with a TIM field set indicating there is data traffic for STA2, so it stays awake and sends a QoS Null data frame to the AP indicating it is awake. STA2 also sets a new timer to a predetermined amount of time, for example, 100 ms, when it senses there is a data frame transmitted to another station on the BSS, for example, STA1. This timer will not expire quickly if STA2 is aware that the AP is busy sending data frames to a peer station, for example, timer expiry is delayed by a predetermined amount of time for each data frame transmitted to a peer station. As shown in FIG. 3, whenever STA2 senses a data frame sent to STA1 by the AP, STA2 resets this timer to 100 ms. In some embodiments, STA2 also has a maximum amount of time waiting for traffic in the presence of traffic delivery to peers on the BSS, for example, the maximum amount of waiting time is 2 seconds. STA2 goes back to sleep if it has waited for 2 seconds regardless of whether there is still data traffic delivering to another station. In the example shown in FIG. 3, the AP starts to transmit data frames to STA2 when the timer is not yet timed out as the AP sends a first data frame to STA2 within 100 ms from sending the last data frame to STA1. STA2 receives its data traffic from the AP without toggling in and out of the power-save mode.

Some embodiments of the power-save mode management method use only one timer to keep the STA awake for a waiting time to wait for data traffic after receiving a beacon frame advertising there is data traffic buffered at the AP for the STA. In some embodiments, the power-save mode management method implemented by a STA includes waking up from a power-save mode, receiving a beacon frame indicating there is data traffic buffered for the STA, staying awake for a while depending on the waiting time, determining whether there is a data frame delivering to a peer station by observing frames transmitted by the AP in the wireless communication network, and extending the waiting time when the STA determines that there is a data frame delivering to a peer station. In some embodiments, a timer is set by the STA to countdown the waiting time after receiving the beacon frame advertising there is buffered data traffic for the STA. An embodiment of extending the waiting time includes setting the timer to a predetermined amount of time each time the STA determines that a data frame is delivering to a peer station. Another embodiment of extending the waiting time includes incrementing the timer by a predetermined amount of time each time the STA determines that a data frame is delivering to a peer station. In some embodiments, the STA also extends the waiting time when it receives a data frame from the AP, in order to receive more data frames from the AP. One embodiment of extending the waiting time includes extending the waiting time only when the recently received data frame indicates there is at least one more data frame buffered at the AP to be sent to the STA. For example, the timer maintains a first timestamp for determining data traffic timeout after receiving a first data frame for the STA, and maintains a second timestamp for determining the waiting time for the buffered data traffic after receiving the beacon frame advertising there is buffered data traffic for the STA. The second timestamp is first programmed into the timer after the STA receives the beacon frame indicating there is data traffic for the STA, and then before the timer expires, the first timestamp is programmed into the timer after receiving a first data frame for the STA from the AP. The timer may be extended based on whether the STA senses a data frame sending to a peer station and whether the STA successfully receives a data frame that has at least one more following data frame to be sent to the STA. The STA enters the power-save mode when the timer either programmed according to the first or second timestamp times out. The STA notifies the AP that it is going to sleep before entering the power-save mode.

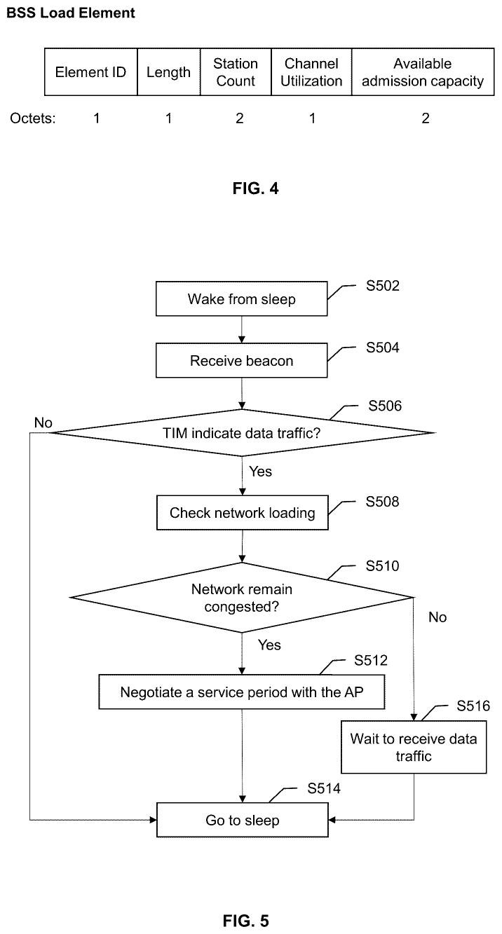

In some alternative embodiments of the present invention, a STA determines the network loading or channel usage while waiting for the data traffic and uses this information to determine whether to stay awake or enter a power-save mode. In one embodiment, a STA in a BSS wakes up from a power-save mode, receives a beacon frame indicating there is data traffic for it, and determines that the network is going to remain congested so traffic delivery from the AP is unlikely to happen in a short period of time. In one embodiment, the STA sets a timer waiting for data traffic delivery from the AP when it receives a notification from the AP advertising there is data traffic for it, and the STA determines whether the network is going to remain congested after the timer is timeout. An alternative embodiment of the present invention further reduces power consumption by further shortening the awake time of the wireless devices waiting for data traffic. For example, the STA determines whether the network is going to remain congested when it receives a notification from the AP advertising there is data traffic for it. The STA enters the power-save mode if the network is going to remain congested, otherwise the STA stays awake waiting for the buffered data traffic from the AP. In some embodiments, the STA negotiates a service period with the AP when it determines the network is going to remain congested, so that the STA may enter the power-save mode until the negotiated service period. For example, the STA negotiates with the AP by scheduling a Target Wake Time (TWT) explicit Service Period (SP) in the future for guaranteed access. An embodiment of the STA determines if the network is going to remain congested by checking information present in the ‘BSS Load element’ of the beacon frame. In this example, the STA uses the BSS Load element as a feedback mechanism for making the decision to dynamically negotiate the TWT SP. The BSS Load element as shown in FIG. 4 contains information of the current STA population and traffic levels in the BSS which can be filled by the AP and inserted into beacon frames. For example, the STA receives a beacon frame from the AP, decodes the BSS Load element in the beacon frame, and determines whether the data traffic is unlikely to arrive anytime soon based on the channel utilization, or based on the station count and the channel utilization.

In an embodiment of negotiating a service period, the STA negotiates a TWT explicit service period for the AP to send the data traffic to the STA when it determines that the network is congested. In another embodiment, the service period negotiated between the STA and AP is protected using a Restricted Access Window (RAW) mechanism. The STA can enter the power-save mode until the negotiated service period, and upon waking up from the power-save mode, access to the medium is reserved for the STA. The AP can schedule and deliver the previously buffered data traffic to the STA upon the STA wakes up in the negotiated service period. In these embodiments of negotiating a service period between the STA and AP, the STA does not need to contend for the medium with other STAs in the BSS. The TWT service period and RAW service period are dynamically negotiated with action frames, such as management frames, which are typically preferred over other data traffic.

In some embodiments of the present invention, a power-save mode management method for a STA observes if there is any data traffic delivering to one or more peer STAs and observes if the network is busy, and consequently determines to stay awake or go back to sleep according to these observations. The STA exits from the power-save mode and receives a first beacon frame indicating there is data traffic for the STA. The STA sets a timer to timeout in X milliseconds (ms) and it may push out the timer when observing data traffic delivering from the AP to its peer STA(s). The STA may restrict the number of times it can push out the timer after observing data traffic delivering to its peer STA(s). In one embodiment, the STA stays awake when the timer is not timeout, receives a new beacon frame, decodes a BSS Load IE in the new beacon frame to check whether there is a high-level of congestion, and goes back to sleep if the STA determines that the network is congested based on the BSS Load IE. In one embodiment, the STA checks the BSS Load IE in the new beacon frame only after observing there is data traffic delivering to a peer STA, that is the new beacon frame may be a second beacon frame, a third beacon frame, or a fourth beacon frame sent by the AP. In another embodiment, the STA checks the BSS Load IE in the new beacon frame when the timer is timeout.

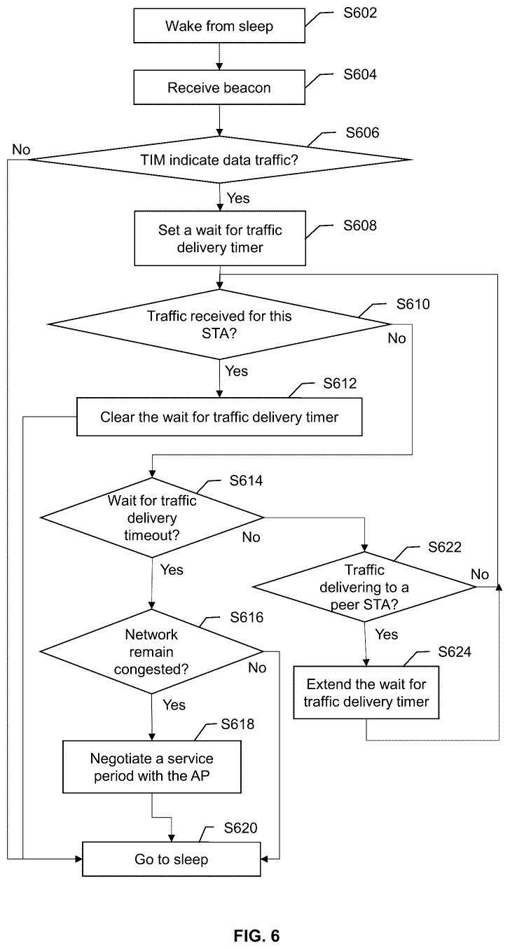

FIG. 5 is a flowchart illustrating an embodiment of the power-save mode management method for a STA to negotiate a service period with an AP when it determines the network is going to remain congested. In steps S502 and S504, the STA wakes up from a power-save mode such as sleeping mode and receives a beacon frame. The STA checks the TIM field in the received beacon frame and determines whether there is data traffic buffered in the AP for the STA in step S506. The STA goes back to sleeping mode in step S514 if the TIM field indicates there is no data traffic for it. In cases when the TIM field is set for the STA, the STA further checks the network loading in step S508. For example, the BSS Load element in the beacon frame is an indication of the current network loading. In step S510, the STA determines if the network is going to remain congested based on the network loading, and it negotiates a service period in the future if the network is going to remain congested in step S512. Then the STA goes back to sleep in step S514 until the negotiated service period. Otherwise, the STA stays awake to wait for the data traffic if the network is not going to remain congested in step S516.

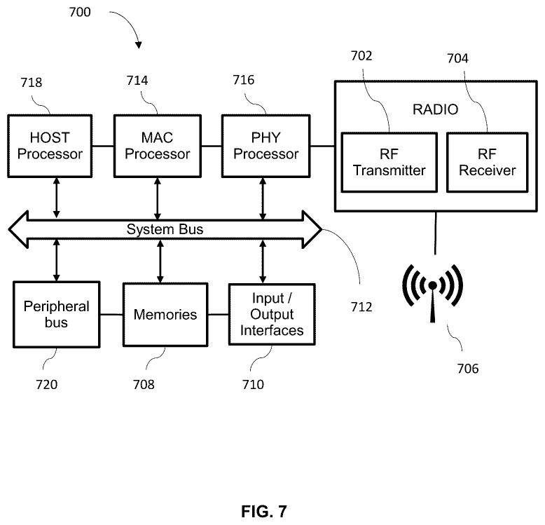

FIG. 6 is a flowchart illustrating another embodiment of the power-save mode management method for a SAT to negotiate a service period with an AP when it determines the network is going to remain congested. The STA wakes up from sleeping mode in step S602 and receives a beacon frame in step S604. In step S606, the STA checks if the TIM field in the received beacon frame indicates there is data traffic buffered in the AP for the STA. The STA returns to sleeping mode in step S620 when the corresponding bit in the TIM field is not set, otherwise, the STA sets a wait for traffic delivery timer in step S608 and stays awake before the timer times out. The STA then waits for data traffic from the AP in step S610. In cases when the STA receives data traffic from the AP, the STA clears the wait for traffic delivery timer in step S612 and goes back to sleep after receiving all the data traffic in step S620. While waiting for the data traffic from the AP and the wait for traffic delivery timer is not yet timeout in S614, the STA checks whether there is data traffic delivering to a peer STA in the network in step S622, for example, by observing one or more data frames sent from the AP, and the STA extends the wait for traffic delivery timer if there is a data frame delivering to a peer STA in step S624. The timer may be extended every time the STA observes a data frame delivering to another STA, however, the timer may be forced to timeout when a predefined condition is met. For example, the timer is forced to timeout after the STA is awake for a predefined period of time. In this embodiment, the STA further checks if the network is going to remain congested in step S616 when the wait for traffic delivery timer is timeout in step S614, and if so, the STA negotiates a service period in the future with the AP in step S618 and goes back to sleep in step S620 until the negotiated service period to reduce power consumption. The STA then wakes up according to the negotiated service period to receive the data traffic from the AP.

FIG. 7 shows a high-level block diagram of a wireless communication device 700 that can be used to implement embodiments of the present invention. The wireless communication device 700 is a Station (STA) wireless connecting to an AP of a BSS, which manages a Media Access Control (MAC) layer and a Physical (PHY) layer. This wireless communication device 700 can be a mobile device, a personal computer, a laptop computer, an Internet of Things (IoT) device, a wearable device, an extended reality device, a video server, a camera, or a communication device on a vehicle. The wireless communication device 700 includes a Radio Frequency (RF) transmitter module 702, an RF receiver module 704, an antenna unit 706, one or more memory banks 708, input and output interfaces 710 and communication bus 712. The RF transmitter module 702 and the RF receiver module 704 are also known as a transceiver or a modem (modulator-demodulator), which transmits data by modulating one or more carrier wave signals to encoded digital information, as well as receives data by demodulating the signal to recreate the original digital information. Furthermore, the wireless communication device 700 includes a MAC processor 714, a PHY processor 716, and a HOST processor 718. These processors can be any type of Integrated Circuit (IC) including a General Processing Unit (GPU), an Application Specific Integrated Circuit (ASIC) or Reduced Instruction Set Computer-Five (RISC-V) based ICs, amongst others. Memory banks 708 store software for the processors of the wireless communication device 700. Each processor executes software to perform the functions of the respective communication/application layer. The PHY processor 716 includes a transmitting signal processing unit and a receiving signal processing unit and manages the interface with the Wireless Medium (WM). The PHY processor 716 operates on Physical Protocol Data Units (PPDUs) by exchanging digital samples with the radio module which comprises the RF transmitter 702, Digital-to-Analog Converters (DACs), the RF receiver 704, Analog-to-Digital Converters (ADCs) and digital filters. The MAC processor 714 executes MAC level instructions and manages the interface between the application software and the WM, through the PHY processor 716. The MAC processor 714 is responsible for coordinating access to the WM so that the AP and STAs in range can communicate effectively. The MAC processor 714 adds header and tail bytes to units of data provided by the higher levels and sends them to the PHY layer for transmission. The reverse happens when receiving data from the PHY layer. If a wireless frame is received in error, the MAC processor 714 manages the retransmission of the wireless frame. The HOST processor 718 interfaces with the MAC layer and is responsible for running high level functionalities of the wireless communication device 700.

The peripheral bus 720 connects to a number of peripherals that support core functions of the wireless communication device 700, for example, the peripherals include timers, interrupts, radio/filters/system registers, counters, Universal Asynchronous Receiver-Transmitter (UART), General Purpose Input Output (GPIO) interfaces and others. The PHY processor 716, the MAC processor 714, the HOST processor 718, the peripheral bus 720, memory banks 708 and input/output interfaces 710, communicate with each other via the system bus 712. Memory banks 708 may further store an operating system and applications. In some embodiments, memory banks 708 may store recorded information about captured frames and packets. The input/output interface unit 710 allows for the exchange of information. The antenna unit 706 may include a single antenna or multiple antennas.

Although the invention is illustrated and described herein with reference to specific embodiments, the invention is not intended to be limited to the details shown. Rather, various modifications may be made in the details within the scope and range of equivalents of the claims and without departing from the invention. It is to be understood that the above description is illustrative of the invention and is not to be construed as limiting the invention. Various modifications, applications and/or combinations of the embodiments may occur to those skilled in the art without departing from the scope of the invention as defined by the claims. Well-known circuits, processes, algorithms, structures, and techniques may be shown without unnecessary detail to avoid obscuring the aspects.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks may be stored in a computer-readable or machine-readable medium. The computer-readable medium may comprise memory or data storage media, such as Random-Access Memory (RAM) such as Synchronous Dynamic Random-Access Memory (SDRAM), Read-Only Memory (ROM), Non-Volatile Random-Access Memory (NVRAM), Electrically Erasable Programmable Read-Only Memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves. The program code may be executed by a processor, which may include one or more processors, such as one or more Digital Signal Processors (DSPs), general purpose microprocessors, an Application Specific Integrated Circuits (ASICs), Field Programmable Logic Arrays (FPGAs), or other equivalent integrated or discrete logic circuitry. Such a processor may be configured to perform any of the steps described in this disclosure. A general-purpose processor may be a microprocessor; alternatively, the processor may be any conventional processor, controller, microcontroller, or state machine. A processor may also be implemented as a combination of computing devices.

To clearly illustrate the interchangeability of hardware and software, various illustrative components, blocks, modules, engines, circuits, and steps have been described above generally in terms of their functionality. Whether such functionality is implemented as hardware or software depends upon the application and design constraints imposed on the overall system. Skilled person may implement the described functionality in varying ways for each application, but such implementation decisions should not be interpreted as causing a departure from the scope of the present application.

What is claimed is:

1. A power-save mode management method for a station (STA) wirelessly connected in a wireless communication network, the power-save mode method comprising:
waking up from a power-save mode;
receiving a beacon frame from an Access Point (AP) of the wireless communication network;
determining the received beacon frame is advertising there is buffered data traffic for the STA;
in response to the received beacon frame advertising there is buffered data traffic for the STA, keeping the STA to stay awake for a period of time waiting for the buffered data traffic from the AP, wherein the STA enters the power-save mode at least after the period of time;
determining there is a data frame delivering to a peer STA in the wireless communication network; and
extending the period of time waiting for the buffered data traffic in response to determining there is a data frame delivering to a peer STA.

2. The power-save mode management method of claim 1, wherein keeping the STA to stay awake for a period of time comprises setting a first timer to a first predetermined amount of time when receiving the beacon frame advertising there is buffered data traffic for the STA, and extending the first timer when there is a data frame delivering to a peer STA;
wherein the STA enters the power-save mode when the first timer is timeout.

3. The power-save mode management method of claim 2, further comprising:
receiving a data frame targeting the STA from the AP; and
setting a second timer and clearing the first timer after receiving the data frame from the AP, wherein the second timer is set to keep the STA awake for a second predetermined amount of time after receiving the data frame waiting for more data frames.

4. The power-save mode management method of claim 3, further comprising extending the second timer every time when receiving a data frame from the AP indicating there is at least one more data frame to be delivered to the STA.

5. The power-save mode management method of claim 4, wherein extending the second timer comprises setting the second timer to the second predetermined amount of time every time when receiving a data frame from the AP indicating there is at least one more data frame to be delivered to the STA.

6. The power-save mode management method of claim 3, further comprising determining the first or second timer is timeout, sending a notification to the AP indicating the STA is going to sleep and entering the power-save mode in response to the first or second timer is timeout.

7. The power-save mode management method of claim 2, further comprising setting the first timer to the first predetermined amount of time each time when there is a data frame delivering to a peer STA.

8. The power-save mode management method of claim 1, further comprising comparing the period of time the STA is awake and not receiving any data frame with a maximum threshold, and entering the power-save mode when the period of time reaches the maximum threshold.

9. The power-save mode management method of claim 1, further comprising sending a notification to the AP indicating the STA is going to sleep and entering the power-save mode after the STA stays awake for the period of time.

10. The power-save mode management method of claim 1, wherein determining there is a data frame delivering to a peer STA comprises parsing and decoding at least a portion of one or more data frames transmitted from the AP.

11. The power-save mode management method of claim 1, wherein keeping the STA to stay awake further comprising setting a timer to countdown the period of time waiting for the buffered data traffic after receiving the beacon frame advertising there is buffered data traffic for the STA.

12. The power-save mode management method of claim 11, wherein extending the period of time comprises setting the timer to a predetermined amount of time each time the STA determines that a data frame is delivering to a peer STA.

13. The power-save mode management method of claim 11, wherein extending the period of time comprises incrementing the timer by a predetermined amount of time each time the STA determines that a data frame is delivering to a peer STA.

14. The power-save mode management method of claim 11, wherein the timer maintains a first timestamp for determining the period of time waiting for the buffered data traffic after receiving the beacon frame advertising there is buffered data traffic for the STA, and maintains a second timestamp for determining data traffic timeout after receiving a data frame for the STA.

15. The power-save mode management method of claim 14, wherein the first timestamp is programmed into the timer after receiving the beacon frame, and the second timestamp is programmed into the timer after receiving a data frame for the STA from the AP, wherein the STA enters the power-save mode when the timer is timeout.

16. The power-save mode management method of claim 1, further comprising:
in response to receiving a beacon frame advertising there is buffered data traffic for the STA, determining whether the wireless communication network is going to remain congested; and
in response to determining that the wireless communication network is going to remain congested, entering the power-save mode, or in response to determining that the wireless communication network is not going to remain congested, staying awake waiting for the buffered data traffic from the AP.

17. The power-save mode management method of claim 16, wherein determining whether the wireless communication network is going to remain congested after waiting for the period of time.

18. The power-save mode management method of claim 16, further comprising:
negotiating a service period with the AP in response to determining that the wireless communication network is going to remain congested;
entering the power-save mode after determining a negotiated service period; and
waking up from the power-save mode according to the negotiated service period.

19. The power-save mode management method of claim 18, wherein the STA negotiates with the AP by scheduling a Target Wake Time (TWT) explicit Service Period (SP) for guaranteed access.

20. The power-save mode management method of claim 16, wherein the STA determines whether the wireless communication network is going to remain congested by checking information present in a Basic Service Set (BSS) Load element.

21. A station (STA) in a wireless communication network associated with an Access Point (AP), comprising:
a Radio Frequency (RF) receiver and a RF transmitter;
a processor, communicatively coupled to the RF receiver and the RF transmitter; and
one or more memory banks, communicatively coupled to the processor and storing processor readable codes that, when executed by the processor, is configured for:
waking up from a power-save mode;
receiving a beacon frame from an Access Point (AP) in the wireless communication network;
determining the received beacon frame is advertising there is buffered data traffic for the STA;
in response to the received beacon frame advertising there is buffered data traffic for the STA, staying awake for a period of time waiting for the buffered data traffic from the AP, wherein the STA enters the power-save mode at least after the period of time;
determining there is a data frame delivering to a peer STA in the wireless communication network; and
extending the period of time waiting for the buffered data traffic in response to determining there is a data frame delivering to a peer STA.
